(19) United States
(12) Patent Application Publication
(10) Pub. No.: US 2009/0283502 A1
(43) Pub. Date: Nov. 19, 2009

(54) PLASMA PROCESSING APPARATUS AND CONTROL METHOD FOR PLASMA PROCESSING APPARATUS

(75) Inventors: Shinji OBAMA, Kudamatsu (JP); Tomoyuki Tamura, Kudamatsu (JP); Ryoji Nishio, Kudamatsu (JP)

Correspondence Address: MCDERMOTT WILL & EMERY LLP, 600 13TH STREET, N.W., WASHINGTON, DC, 20005-3096, US

(73) Assignee: HITACHI HIGH-TECHNOLOGIES CORPORATION

(21) Appl. No.: 12/191,016

(22) Filed: Aug. 13, 2008

(30) Foreign Application Priority Data
May 15, 2008 (JP) 2008-127820

(51) Int. Cl. B23K 9/00

(52) U.S. Cl. 219/121.36

(57) ABSTRACT

A unit for minimizing the problem that affects a substrate to be processed at the time of turning off a plasma is provided in a plasma processing apparatus using a magnetic field. The plasma processing apparatus comprises: a plasma-generating high-frequency power supply; a bias power supply; and a coil power supply which is connected to a coil disposed outside a vacuum process chamber and generates a magnetic field inside the vacuum process chamber, and the plasma processing apparatus further comprises: a magnetic field measuring unit which measures a magnetic field strength inside the vacuum process chamber; and a control unit which turns off an output on/off signal of the plasma-generating high-frequency power supply or the bias power supply when a magnetic field strength, which is measured after an output on/off signal of the coil power supply is turned off, decays to a predetermined value.

### BACKGROUND OF THE INVENTION

The present invention relates to a plasma processing apparatus for performing micro-processing to samples, such as wafers, in semiconductor manufacturing process, and a control method for the plasma processing apparatus. In particular, the present invention relates to a plasma processing apparatus using a magnetic field and a control method for the plasma processing apparatus.

In the semiconductor manufacturing process, a plasma etching apparatus is used to perform micro-processing to the surface of a substrate to be processed (wafer). In the plasma etching apparatus, a gas is flowed into a process chamber, where an electric field, a magnetic field, and the like are applied to plasmanize the gas. Plasma is in a very reactive active-state, and brings about a physical/chemical reaction with a film on the substrate to be processed, thereby performing etching. For the etching of an insulation layer composed of SiO₂ or a low-K material, a plasma processing apparatus of narrow-gap/two-frequencies/parallel-plate type is usually used. For the development of a nano-order level fine-processing technology, it is necessary to generate a high density plasma and attract the activated species, such as ions, to a substrate to be processed, with excellent selectivity, For this reason, a high frequency bias is applied to a lower electrode. The use of a high frequency reduces the processing time of the film and improves the selectivity, thereby enabling a uniform etching. However, for example, an increase in the frequency of a bias applied to the lower electrode from about 800 KHz up to 1 MHz-10 MHz and the use of a narrow gap (e.g., the distance between the upper electrode and the lower electrode for mounting thereon a substrate to be processed is 30 mm) may affect the distribution of plasma. This may cause a slight deviation of the charge distribution on the substrate to be processed, resulting in a potential difference in the plane of the substrate to be processed. Then, a charge-up damage (where a gate insulation film is destroyed by this potential difference) is a problem.

FIG. 4 shows a schematic view of a related art plasma processing apparatus.

Inside a vacuum process chamber 1, there are provided a lower electrode 4 for mounting thereon a substrate to be processed 3 and an upper electrode 2 arranged opposite thereto. Then, a coil 7 (magnetic field generating unit) and yoke for generating a magnetic field inside the vacuum process chamber 1 are provided outside the process chamber. A current flowing through the coil 7 generates a magnetic field inside the vacuum process chamber 1.

A plasma-generating high-frequency power supply 5 is connected to the upper electrode 2 and a bias power supply 6 is connected to the lower electrode 4 as well, and these power supplies form an electric field inside the vacuum process chamber 1 to plasmanize a reactive gas. Ions in the plasma are collided with the surface of the substrate to be processed 3 placed on the lower electrode 4 by the lower-part bias power, thereby accelerating the etching reaction.

Moreover, with the use of the coil magnetic field, the electrons trapped by the magnetic lines of force facilitate the ionization of the gas, thereby generating a high-density plasma. Then, particles to diffuse to the side wall inside the process chamber can be confined by the magnetic field and the plasma can be controlled electromagnetically.

A control unit capable of controlling the on/off of the power supplies and outputting the recipe setting values for etching the substrate to be processed 3 is connected to the plasma-generating high-frequency power supply 5, the bias power supply 6, and the coil power supply 8. For a series of flow from the generation of a plasma to the turning-off thereof, an on-signal is sent from the control unit 10 to the plasma-generating high-frequency power supply 5, the bias power supply 6, and the coil power supply 8, and then a signal is sent to output the recipe condition values for processing the substrate to be processed. Thus, a plasma is generated to etch the substrate to be processed 3. Upon completion of the etching, an off-signal is sent to each power supply to turn off the plasma. The on/off of each power supply can be controlled with temporally different timings by changing the timing of signal transmission of the control unit 10.

For the plasma generated inside the vacuum process chamber 1, the distribution of plasma is stable due to the magnetic field caused by the coil 7 and the electric field between the upper and lower electrodes. For this reason, a uniform potential is established in the plane of the substrate to be processed 3. However, when the plasma is turned off, a residual magnetic field inside the vacuum process chamber 1 caused by turning off the coil current and the breakdown of a balance between the electric fields caused by turning off the plasma-generating high-frequency power supply 5 and the bias power supply 6 may change the distribution of plasma to cause a variation in the potential on the substrate to be processed 3.

FIG. 5 is a view showing a related art timing chart for turning off a plasma.

A solid line indicates the timing of an output on/off signal of the coil power supply 8 when turning off the plasma, a dotted line indicates the timing of an output on/off signal of the plasma-generating high-frequency power supply 5, and a dashed dotted line indicates the timing of an output on/off signal of the bias power supply 6.

Conventionally, when the coil current is turned off first from a steady state where the plasma is stably turned on, a decay of the magnetic field distorts the distribution of plasma significantly and causes a deviation of the electric charges in the plane of the substrate to be processed, especially in a narrow gap process where the gap length between the upper and lower electrodes is 30 nm, for example.

On the other hand, the frequency of the conventionally used bias power supply 6 applied to the lower electrode 4 is 800 kHz, which is not in the frequency band that affects the distribution of plasma.

From this fact, the coil current is turned off lastly, taking into account the effect of a distortion caused by the decay of the magnetic field.

As the turning-off timing of the plasma, the bias power supply 6 is turned off first (t1). Then, the discharging is conducted only with the plasma-generating high-frequency power supply 5, and the plasma-generating high-frequency power supply 5 is turned off in 5 seconds after the discharging becomes stable (t2). Then, by lastly turning off the coil power supply 8 (t3), an influence on the distribution of plasma, which the residual magnetic field inside the vacuum process chamber 1 after turning off the coil current has, is reduced.

A prior art for detecting and controlling a magnetic field in a plasma processing apparatus using a magnetic field is described in JP-A-2001-156044, for example. In JP-A-2001-156044, there is proposed an etching processing apparatus having a role to cancel a magnetic field by operating in a direction opposite to the operating direction of a dipole magnet ring, wherein upon detection of a leakage magnetic field that affects a peripheral equipment outside a vacuum process chamber, a shield plate is operated in a direction opposite to the operating direction of the dipole magnet ring to shut off the leakage magnetic field.

### SUMMARY OF THE INVENTION

The uniformity in the distribution of plasma may not be maintained with the related art timing for turning off the plasma, due to an increase in the frequency of the plasma-generating high-frequency power supply or the bias source in order to improve the etching performance of a substrate to be processed. This is because an electric field between the electrodes will fluctuate significantly, at the time of turning off the plasma, by temporally ordering the timing to turn off the high-frequency power which has been applied to the upper and lower electrodes. Furthermore, if a magnetic field exists in the fluctuating electric field, a parasitic discharge or the like may occur. Moreover, a change in the distribution of plasma on the substrate to be processed may bring about a change for each area in the potential in the plane, resulting in a charge-up damage problem. For this reason, a control method that takes into account the residual magnetic field due to the coil current and the field strength between the upper and lower electrodes has been required.

It is an object of the present invention to provide an innovative and improved plasma processing apparatus capable of minimizing the problem that affects a substrate to be processed at the time of turning off a plasma, in a plasma processing apparatus using a magnetic field, and a control method thereof.

In order to solve the above-described problems, a plasma processing apparatus according to the present invention includes: a vacuum process chamber; an upper electrode provided inside the vacuum process chamber; a lower electrode for mounting thereon a substrate to be processed, the lower electrode being provided opposite to the upper electrode; a plasma-generating high-frequency power supply which is connected to the upper electrode and generates a plasma inside the vacuum process chamber, a bias power supply which is connected to the lower electrode and accelerates an ion in a plasma; and a coil power supply which is connected to a coil disposed outside the vacuum process chamber and generates a magnetic field inside the vacuum process chamber, and the plasma processing apparatus further includes: a magnetic field measuring unit which measures a magnetic field strength inside the vacuum process chamber; and a control unit which turns off an output on/off signal of the plasma-generating high-frequency power supply or the bias power supply when a magnetic field strength, which is measured after an output on/off signal of the coil power supply is turned off, decays to a predetermined value.

Further, the control unit, after turning off the output on/off signal of the plasma-generating high-frequency power supply or the bias power supply, controls an output value of the plasma-generating high-frequency power supply or the bias power supply so as to gradually approach to zero from a predetermined value, in synchronization with a timing when a value of the magnetic field strength to be measured becomes zero.

Moreover, a plasma processing apparatus includes: a vacuum process chamber; an upper electrode provided inside the vacuum process chamber; a lower electrode for mounting thereon a substrate to be processed, the lower electrode being provided opposite to the upper electrode; a plasma-generating high-frequency power supply which is connected to the upper electrode and generates a plasma inside the vacuum process chamber, a bias power supply which is connected to the lower electrode and accelerates an ion in a plasma; and a coil power supply which is connected to a coil disposed outside the vacuum process chamber and generates a magnetic field inside the vacuum process chamber, and the plasma processing apparatus further includes: a database which stores therein at least information on a magnetic field decay time of a residual magnetic field after turning off the output on/off signal of the coil power supply, an electron temperature in a generated plasma, and a flux density inside the vacuum process chamber caused by a current flowing through the coil; and a control unit which turns off the output on/off signal of the plasma-generating high-frequency power supply or the bias power supply based on the database.

Moreover, in a control method for a plasma processing apparatus including a vacuum process chamber; an upper electrode provided inside the vacuum process chamber; a lower electrode for mounting thereon a substrate to be processed, the lower electrode being provided opposite to the upper electrode; a plasma-generating high-frequency power supply which is connected to the upper electrode and generates a plasma inside the vacuum process chamber; a bias power supply which is connected to the lower electrode and accelerates an ion in a plasma; and a coil power supply which is connected to a coil disposed outside the vacuum process chamber and generates a magnetic field inside the vacuum process chamber, the method includes the steps of: firstly turning off an output on/off signal of the coil power supply after processing the substrate to be processed and when turning off a plasma; then turning off an output on/off signal of the plasma-generating high-frequency power supply or the bias power supply in synchronization with a timing when a value of a magnetic field strength inside the vacuum process chamber decays to a predetermined value; and furthermore controlling an output value of the plasma-generating high-frequency power supply or the bias power supply so as to gradually approach to zero from a predetermined value, in synchronization with a timing when the value of the magnetic field strength inside the vacuum process chamber becomes zero.

According to the present invention, it is possible to eliminate, from a high density plasma state caused by the magnetic field and the electric field of the high-frequency power applied to the upper and lower electrodes, a non-uniformity of the distribution of plasma due to a fluctuation of the magnetic field or the electric field at the time of turning off the plasma, and also possible to turn off the plasma being in a stable distribution. As a result, a parasitic discharge can be prevented and the charge-up damage can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a schematic view of a plasma processing apparatus according to a first embodiment of the present invention.

FIG. 2A is a view showing a timing chart for turning off a plasma, according to the present invention.

FIG. 2B is a view showing another example of a timing chart for turning off a plasma, according to the present invention.

FIG. 3 is a schematic view of a plasma processing apparatus according to a second embodiment of the present invention.

FIG. 4 is a schematic view of a related art plasma processing apparatus.

FIG. 5 is a view showing a related art timing chart for turning off a plasma.

### DETAILED DESCRIPTION OF THE EMBODIMENTS

### Embodiment 1

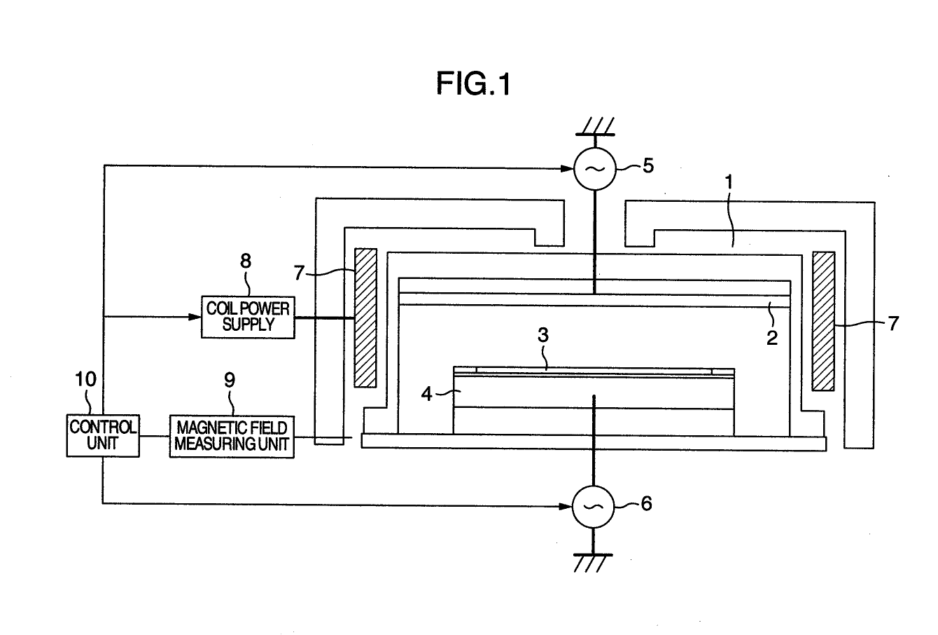

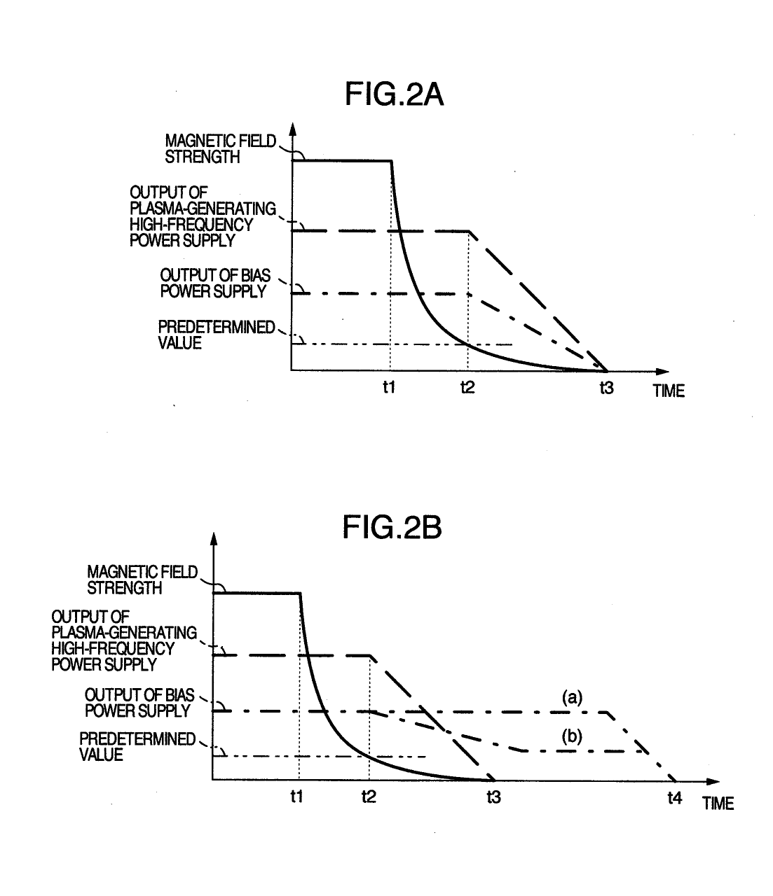

A plasma processing apparatus of a first embodiment of the present invention will be described using FIG. 1, FIG. 2A, and FIG. 2B.

FIG. 1 is a schematic view of the plasma processing apparatus according to the first embodiment of the present invention.

The plasma processing apparatus includes: the vacuum process chamber 1 for performing vacuum processing to the substrate to be processed 3; the upper electrode 2 provided inside the vacuum process chamber 1; the lower electrode 4 for mounting thereon the substrate to be processed 3, the lower electrode 4 being provided opposite to the upper electrode 2; the plasma-generating high-frequency power supply 5 which is connected to the upper electrode 2 and generates a plasma inside the vacuum process chamber 1 (with a frequency of 100 MHz to 500 MHz); the bias power supply 6 which is connected to the lower electrode 4 and accelerates an ion in a plasma (with a frequency of 1 MHz to 10 MHz); and the coil power supply 8 which is connected to the coil 7 disposed outside the vacuum process chamber 1 and generates a magnetic field inside the vacuum process chamber 1, and the plasma processing apparatus further includes a magnetic field measuring unit 9 for measuring a magnetic field inside the vacuum process chamber 1, and a control unit 10 which controls various kinds of apparatus signals required to operate the plasma processing apparatus.

The plasma-generating high-frequency power supply 5, the bias power supply 6, the coil power supply 8, the magnetic field measuring unit 9, and the like are connected to the control unit 10.

Although the distance between the upper electrode 2 and the lower electrode 4 is set to 30 mm, it can be changed within the range of 10 mm to 50 mm.

The magnetic field measuring unit 9 may be attached to a yoke that supports the coil 7 provided in the air, for example.

The magnetic field measuring unit 9 measures a decay of a magnetic field strength inside the vacuum process chamber 1 after turning off the coil power supply 8, for example, after processing the substrate to be processed 3 and when turning off the plasma.

Then, when the magnetic field strength decays to a predetermined value, an output on/off signal of the plasma-generating high-frequency power supply 5 or the bias power supply 6 is turned off by the control unit 10.

Moreover, the output value of the plasma-generating high-frequency power supply 5 or the bias power supply 6 is turned off so as to gradually approach to zero from a predetermined value (at the time of processing), i.e., with a temporal gradient, in synchronization with a timing when the value of a magnetic field to be measured becomes zero after turning off each output on/off signal.

In other words, in reducing the output value of the plasma-generating high-frequency power supply 5 or the bias power supply 6 to zero from the output value at the time of processing the substrate to be processed 3, in order to prevent a distribution of electric fields between the electrodes from significantly varying due to an abrupt change in the power (e.g., such a control that reduces the power to 0 W in 50 ms when turning off from a state of 200 MHz, 1000 W) this time period can be changed from 50 ms to 300 ms.

In a steady state where the plasma is stably turned on, the electrons and ions are trapped by the magnetic lines of force due to the magnetic field and perform a circling movement. Since the Larmor radius Pe of an electron is small, the electron performs the circling movement at high speed to ionize the gaseous species one after another, thereby generating a high-density plasma. If the magnetic field strength inside the vacuum process chamber caused by a current flowing through the coil is 60 to 75 Gauss, for example, the turning radius of an electron is no more than several mm.

However, if the magnetic field strength becomes 2 to 3 Gauss or less, for example, the Larmor radius Pe of the electron trapped by the magnetic field becomes longer than the length between the upper and lower electrodes (e.g., gap of 30 mm) in accordance with the following equation, and the electron can be regarded as performing a free movement.

Electron cyclotron frequency wce=eB/me

Larmor radius Pe=(2kBTe/me)̂0.5/wce

where, kB: Boltzmann constant, Te: electron temperature, me: electron mass, e: elementary charge amount, B: flux density.

Taking into account the above, in the present invention the timings of a decay of the magnetic field and a decay of the electric field are controlled, so that a distortion in the plasma caused by the magnetic field and the electric field can be eliminated and a deviation of electric charges on the substrate to be processed can be eliminated.

FIG. 2A is a view showing a timing chart for turning off a plasma, according to the present invention.

A solid line indicates a magnetic field strength inside the vacuum process chamber 1, a dotted line indicates the output of the plasma-generating high-frequency power supply 5, and a dashed dotted line indicates the output of the bias power supply 6.

If the output on/off signal of the coil power supply 8 is turned off, first, (t1) after processing the substrate to be processed 3 and when turning off the plasma, then the magnetic field strength inside the vacuum process chamber 1 will decay exponentially. Next, if the magnetic field measuring unit 9 detects, taking into account the Larmor radius of an electron, a timing t2 when the magnetic field strength inside the vacuum process chamber 1 becomes less than a predetermined value (e.g., around 2 to 3 Gauss), the output on/off signal of the plasma-generating high-frequency power supply 5 or the bias power supply 6 is turned off. Furthermore, the output value of the plasma-generating high-frequency power supply 5 or the bias power supply 6 is controlled so as to gradually approach to zero from a predetermined value, in synchronization with a timing (t3) when the value of the magnetic field strength inside the vacuum process chamber 1 becomes zero.

FIG. 2B is a view showing another example of a timing chart for turning off a plasma, according to the present invention.

When you desire to secure the sheath thickness on the substrate to be processed 3, it is preferable to reduce the output of the bias power supply 6 to zero at a timing of t4 after reducing the output of the plasma-generating high-frequency power supply 5 to zero (a). Moreover, at the same timing as the timing (t2) when starting to reduce the output of the plasma-generating high-frequency power supply 5, the output of the bias power supply 6 may be reduced to a certain value and then after the output of the plasma-generating high-frequency power supply 5 becomes completely zero, the output of the bias power supply 6 may be reduced to zero at a timing of t4 (b). Since this makes it possible to turn off the plasma while maintaining a high-density plasma state, a problem, such as the charge-up damage, can be resolved.

### Embodiment 2

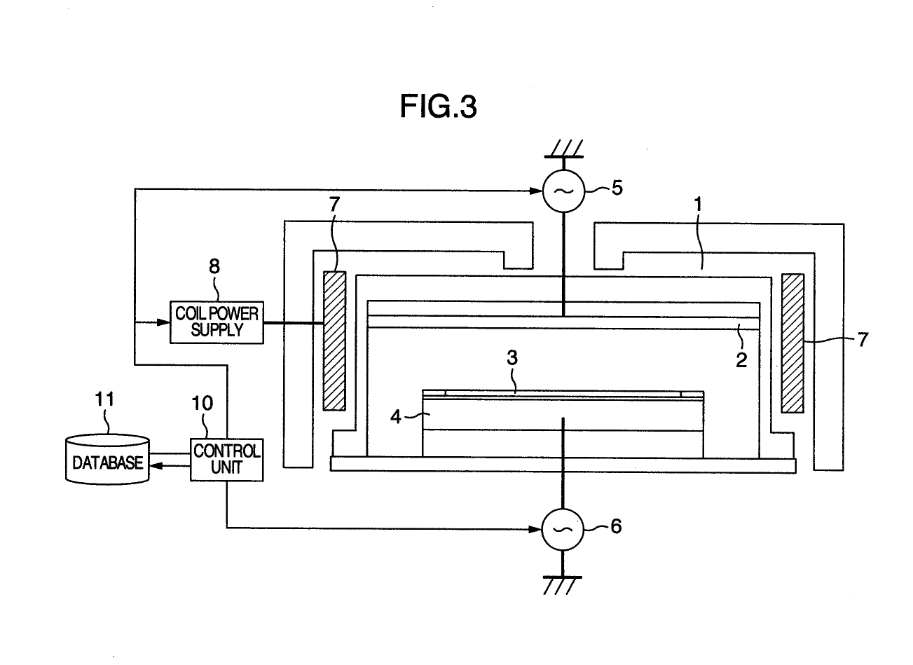

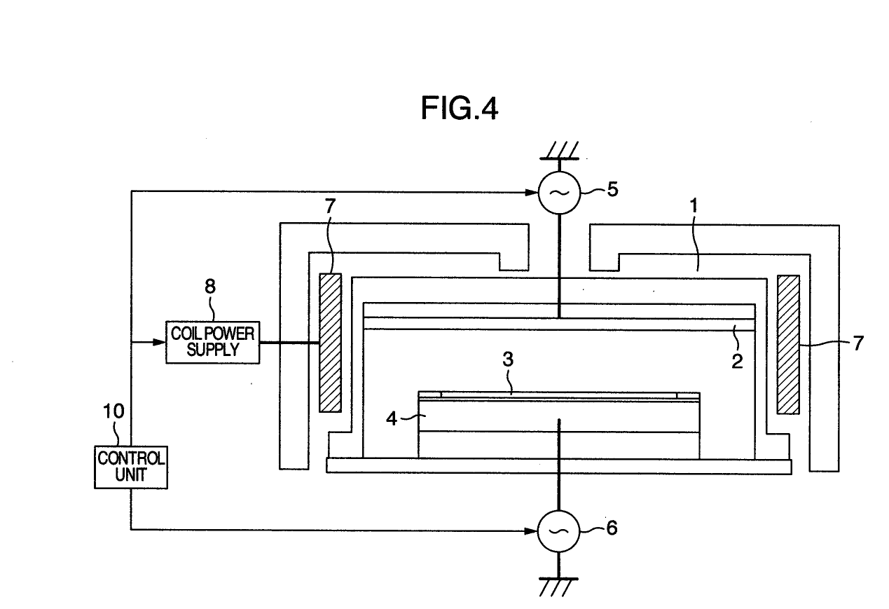

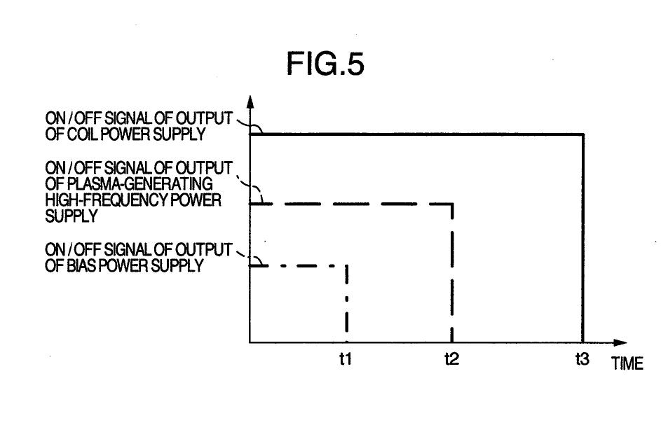

A plasma processing apparatus of a second embodiment of the present invention is described using FIG. 3.

FIG. 3 is a schematic view of the plasma processing apparatus according to the second embodiment of the present invention.

The plasma processing apparatus, instead of including the magnetic field measuring unit 9 described in the first embodiment, includes; a database 11 that stores therein at least information on: a magnetic field decay time of a residual magnetic field inside the vacuum process chamber 1 after turning off the output on/off signal of the coil power supply; the electron temperature inside a generated plasma; and the flux density inside the vacuum process chamber 1 caused by a current flowing through the coil, these being measured in advance.

Since several films are stacked above the substrate to be processed 3, the recipe condition of the etching varies depending on each film. For this reason, the value which each power supply outputs will differ, and it is thus necessary to take into account the turning-off timing of each power supply for turning off the plasma while the potential distribution in the plane on the substrate to be processed 3 is kept uniform.

In this embodiment, from the coil current setting value under the used recipe condition, the decay time of the residual magnetic field when turning off the power supply, the electron temperature in the plasma, and the flux density inside the process chamber are measured and stored in the database 11 in advance. Accordingly, the control unit 10 can calculate the Larmor radius using these information and change the turn-off timing of each power supply, thereby turning off the plasma while maintaining the in-plane potential distribution uniform.

As described above, the embodiments of the present invention have been described taking a reduction in the charge-up damage of a plasma etching apparatus as an example, but other than these embodiments, the present invention can be also applied to various kinds of apparatuses which perform plasma processing by using a magnetic field and applying a high-frequency power to both the upper electrode and the lower electrode.

It should be further understood by those skilled in the art that although the foregoing description has been made on embodiments of the invention, the invention is not limited thereto and various changes and modifications may be made without departing from the spirit of the invention and the scope of the appended claims.

1. A plasma processing apparatus, comprising: a vacuum process chamber; an upper electrode provided inside the vacuum process chamber; a lower electrode for mounting thereon a substrate to be processed, the lower electrode being provided opposite to the upper electrode; a plasma-generating high-frequency power supply which is connected to the upper electrode and generates a plasma inside the vacuum process chamber, a bias power supply which is connected to the lower electrode and accelerates an ion in a plasma; and a coil power supply which is connected to a coil disposed outside the vacuum process chamber and generates a magnetic field inside the vacuum process chamber; the plasma processing apparatus further comprising:
a magnetic field measuring unit which measures a magnetic field strength inside the vacuum process chamber; and
a control unit which turns off an output on/off signal of the plasma-generating high-frequency power supply or the bias power supply when a magnetic field strength, which is measured after an output on/off signal of the coil power supply is turned off, decays to a predetermined value.

2. The control plasma processing apparatus according to claim 1, wherein after turning off the output on/off signal of the plasma-generating high-frequency power supply or the bias power supply, the control unit controls an output value of the plasma-generating high-frequency power supply or the bias power supply so as to gradually approach to zero from a predetermined value, in synchronization with a timing when a value of the magnetic field strength to be measured becomes zero.

3. A plasma processing apparatus, comprising: a vacuum process chamber; an upper electrode provided inside the vacuum process chamber; a lower electrode for mounting thereon a substrate to be processed, the lower electrode being provided opposite to the upper electrode; a plasma-generating high-frequency power supply which is connected to the upper electrode and generates a plasma inside the vacuum process chamber, a bias power supply which is connected to the lower electrode and accelerates an ion in a plasma; and a coil power supply which is connected to a coil disposed outside the vacuum process chamber and generates a magnetic field inside the vacuum process chamber; the plasma processing apparatus further comprising:
a database which stores therein at least information on a magnetic field decay time of a residual magnetic field after turning off the output on/off signal of the coil power supply, an electron temperature inside a generated plasma, and a flux density inside the vacuum process chamber caused by a current flowing through the coil; and
a control unit which turns off an output on/off signal of the plasma-generating high-frequency power supply or the bias power supply based on the database.

4. A control method for a plasma processing apparatus comprising: a vacuum process chamber; an upper electrode provided inside the vacuum process chamber; a lower electrode for mounting thereon a substrate to be processed, the lower electrode being provided opposite to the upper electrode; a plasma-generating high-frequency power supply which is connected to the upper electrode and generates a plasma inside the vacuum process chamber; a bias power supply which is connected to the lower electrode and accelerates an ion in a plasma; and a coil power supply which is connected to a coil disposed outside the vacuum process chamber and generates a magnetic field inside the vacuum process chamber, the method comprising the steps of:
turning off an output on/off signal of the coil power supply after processing the substrate to be processed and when turning off a plasma; then turning off an output on/off signal of the plasma-generating high-frequency power supply or the bias power supply in synchronization with a timing when a value of a magnetic field strength inside the vacuum process chamber decays to a predetermined value; and
controlling an output value of the plasma-generating high-frequency power supply or the bias power supply so as to gradually approach to zero from a predetermined value, in synchronization with a timing when the value of the magnetic field strength inside the vacuum process chamber becomes zero.
